(19) United States
(12) Patent Application Publication
(10) Pub. No.: US 2011/0132882 A1
(43) Pub. Date: Jun. 9, 2011

(54) Filler for the Drilling of Through-Holes in Hollow Components, a Process and Apparatus Therefor

(76) Inventors: Wolfgang Dorn, Berlin (DE); Francis-Jurjen Ladru, Berlin (DE); Michael Riemann, Berlin (DE)

(21) Appl. No.: 12/958,657

(22) Filed: Dec. 2, 2010

(30) Foreign Application Priority Data
Dec. 4, 2009 (EP) 09015077.2

(51) Int. Cl. B23K 26/38; C03C 12/00; C03C 12/02

(52) U.S. Cl. 219/121.71; 501/33; 501/34; 428/402; 219/121.7

(57) ABSTRACT

A filler made of glass beads is provided. The glass improves the absorption and the distribution of the energy of the beam such that an internal wall of the hollow component is not damaged. A process for producing a through-hole in a hollow component is provided. Also, an apparatus for laser drilling is provided.

### CROSS REFERENCE TO RELATED APPLICATIONS

This application claims priority of European Patent Office application No. 09015077.2 EP filed Dec. 4, 2009, which is incorporated by reference herein in its entirety.

### FIELD OF INVENTION

The invention relates to a filler for the drilling of hollow components, in which a through-hole is produced through an outer wall, and also to a process and an apparatus therefor.

### BACKGROUND OF INVENTION

Components such as, for example, turbine blades or vanes have film-cooling holes as through-holes which are introduced after the component has been cast.

For this purpose, lasers or electron beams are used to produce the hole in an outer wall. In the case of a hollow component, the cavity is generally filled with a material in order to prevent excessive damage to an internal wall when the hole is shot through at the end of the process. This can be done by filling with UV-curable material.

However, this is not always adequate, e.g. when the material evaporates and then escapes outward through the hole.

In addition, the introduction and removal of the material is time-consuming.

### SUMMARY OF INVENTION

It is therefore an object of the invention to solve the above-mentioned problem.

The object is achieved by a filler as claimed in the claims, a process as claimed in the claims and an apparatus as claimed in the claims.

The dependent claims list further advantageous measures which can be combined with one another, as desired, in order to obtain further advantages.

### BRIEF DESCRIPTION OF THE DRAWINGS

FIG. 1 shows an arrangement for carrying out the process with such a filler,

FIG. 2 shows a turbine blade or vane, and

FIG. 3 shows a list of superalloys.

The figures and the description represent merely exemplary embodiments of the invention.

### DETAILED DESCRIPTION OF INVENTION

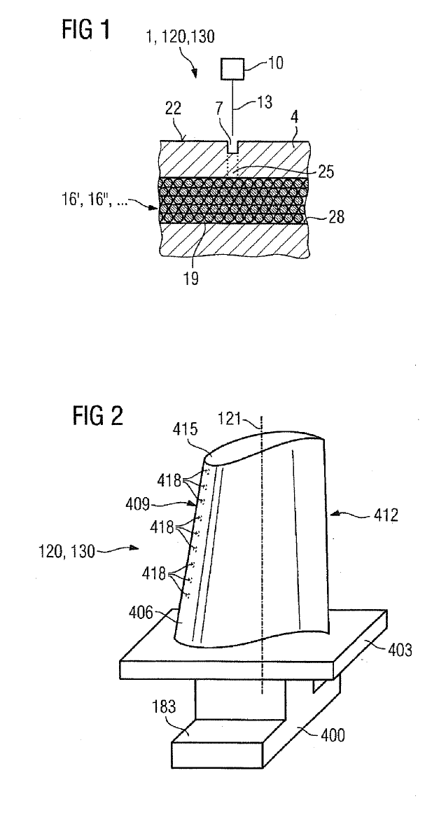

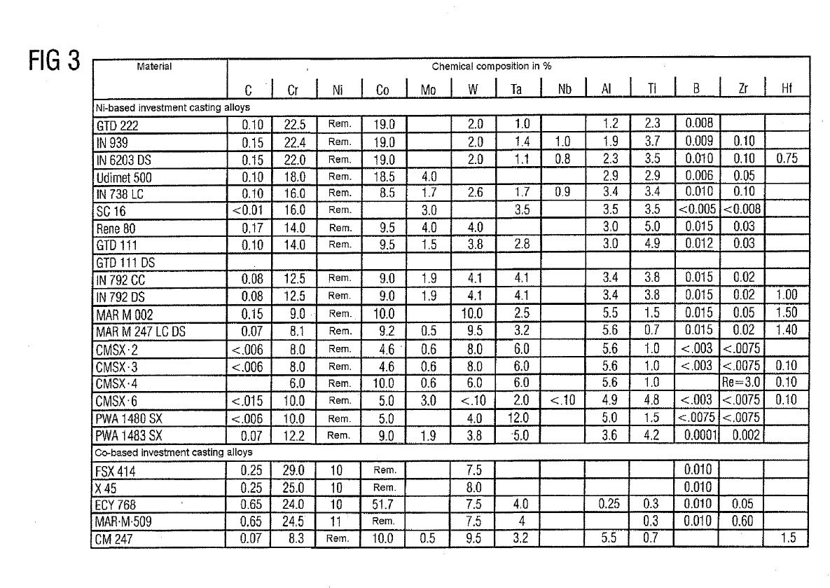

FIG. 1 shows a subregion of a component 1, 120, 130.

The component 1 is preferably an internally cooled turbine blade or vane 120, 130, and so the component 1, 120, 130 has a cavity 19.

A hole 7 is produced starting from the outer surface 22 of an outer wall 4.

In its final state, the hole 7 should provide a through-hole, as shown by dotted lines in FIG. 1.

A laser 10 which emits laser beams 13 that evaporate the material of the wall 4 is preferably used for drilling.

It is likewise also possible to use electron beams or other high-energy beams.

The problem during the process is that, when the last region 25 of the through-hole 7 is produced, some of the laser beams can penetrate into the cavity 19 and damage an opposite wall 28 in the cavity 19.

To counter this, a filler 16′, 16″, 16′ is introduced into the cavity 19 in order to protect the internal wall 28.

According to the invention, here beads 16′, 16″, . . . , in particular glass beads, are introduced into the cavity 19.

The purpose of the beads 16′, 16″, . . . is to absorb and/or reflect the energy beam (laser beam).

The glass beads preferably have a diameter ≦5 mm, in particular ≦2 mm, very particularly ≦1.2 mm. It is preferably also possible to use different bead diameters, e.g. smaller beads can fill the intermediate space between relatively large beads in order to achieve a higher packing density.

The diameter is preferably at least 0.1 mm, in particular 0.3 mm.

In this case, use is preferably made of a silicate glass or a beryllium glass.

No particularly high demands are made on the glass beads with respect to roundness or surface quality so as to avoid focusing.

The absorption process of the laser energy or of the energy beams can likewise be improved by colored glass beads, preferably green or blue glass beads.

If the laser or the energy beam impinges on one such glass bead or on a plurality of such glass beads, the laser energy is split up, and so the energy of the laser beam which is split up or the propagation of the laser beam no longer suffices for damage to occur on the opposite wall. The energy beam is consumed by dimensional defects and the surface quality.

The energy is also absorbed if the laser beam impinges on the glass bead in solid form and the latter shatters. The cavity which thereby becomes free is filled by other glass beads, which move forward. This is done automatically owing to the dead weight of the glass beads.

The beads may have a solid or porous form.

The glass bead or the remainder of the glass beads can simply be removed from the interior of the component 1 or the turbine blades or vanes 120, 130 by simply pouring them out or by slightly shaking them mechanically. As opposed to the use of wax or other materials, renewed heating and emptying by softening the filler does not have to take place. This accelerates the removal of the filler considerably.

FIG. 2 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (HO). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1.-11. (canceled)

12. A filler for the drilling of through-holes in a hollow component, comprising:
a plurality of absorbing or reflecting beads.

13. The filler as claimed in claim 12, wherein the plurality of absorbing or reflecting beads are a plurality of glass beads.

14. The filler as claimed in claim 13, wherein the plurality of glass beads include a diameter ≦5 mm.

15. The filler as claimed in claim 14, wherein the plurality of glass beads include the diameter of ≦2 mm.

16. The filler as claimed in claim 14, wherein the plurality of glass beads include the diameter of ≦1.2 mm.

17. The filler as claimed in claim 13, wherein the plurality of glass beads comprise a silicate glass.

18. The filler as claimed in claim 13, wherein the plurality of glass beads consists of a silicate glass.

19. The filler as claimed in claim 13, wherein the plurality of glass beads comprise a beryllium glass.

20. The filler as claimed in claim 13, wherein the plurality of glass beads are colored.

21. The filler as claimed in claim 20, wherein the plurality of glass beads are green or blue.

22. The filler as claimed in claim 12, wherein the plurality of absorbing or reflecting beads include different diameters.

23. The filler as claimed in claim 12, wherein the plurality of absorbing or reflecting beads include a solid form.

24. The filler as claimed in claim 12, wherein the plurality of absorbing or reflecting beads include a hollow or porous form.

25. The filler as claimed in claim 12, wherein the component is an internally cooled turbine blade or vane.

26. A process for producing a through-hole in a hollow component through a wall of the hollow component, comprising:
arranging a filler in the cavity around the through-hole; and
impinging an energy beam on the filler,
wherein the filler, comprises:
a plurality of absorbing or reflecting beads.

27. The process as claimed in claim 26, wherein a laser is used to produce the through-hole.

28. The process as claimed in claim 26, further comprising removing the filler by pouring the filler out or by shaking the filler out mechanically.

29. An apparatus for laser drilling, comprising:
a laser;
a holding apparatus for a component;
a component; and
a filler in the component, the filler comprising:
a plurality of absorbing or reflecting beads.
